(19) United States
(12) Patent Application Publication
(10) Pub. No.: US 2014/0090849 A1
(43) Pub. Date: Apr. 3, 2014

(54) Methods and Compositions for In Situ Microemulsions

(71) Applicant: Baker Hughes Incorporated, Houston, TX (US)

(72) Inventors: James B. Crews, Willis, TX (US); Tianping Huang, Spring, TX (US)

(73) Assignee: Baker Hughes Incorporated, Houston, TX (US)

(21) Appl. No.: 14/037,017

(22) Filed: Sep. 25, 2013

Related U.S. Application Data
(60) Provisional application No. 61/707,456, filed on Sep. 28, 2012.

(51) Int. Cl. C09K 8/584; E21B 43/16; C09K 8/536

(52) U.S. Cl. CPC C09K 8/584; C09K 8/536; E21B 43/16
USPC 166/308.2; 507/203

(57) ABSTRACT

A plurality of first VES micelles may be converted into second VES micelles for subsequent formation of an in situ microemulsion downhole. The in situ microemulsion may include at least a portion of second VES micelles, e.g. spherical micelles, and a first oil-based internal breaker to initially aid in breaking the VES gelled aqueous fluid. The in situ microemulsion may increase the rate of flowback of an internally broken VES treatment fluid, increase the volume of treatment fluid recovered, increase the relative permeability or decrease water saturation of a hydrocarbon stream, e.g. oil, gas, and the like; reduce capillary pressure and water-block in the reservoir; enhance the solubilization and dispersion of VES molecules, internal breakers, and/or internal breaker by-products produced when breaking a VES gel; reduce the interfacial tension and/or the contact angle at the fluid-rock interface, reduce the water/oil interfacial tension, keep the reservoir surfaces water-wet, etc.

### CROSS-REFERENCE TO RELATED APPLICATION

This application claims the benefit of Provisional Patent Application No. 61/707,456 filed Sep. 28, 2012, which is incorporated by reference herein in its entirety.

### TECHNICAL FIELD

The present invention relates to methods and compositions comprising in situ microemulsions generated downhole, and more particularly relates, in one non-limiting embodiment, to in situ microemulsions that may be generated from breaking the viscosity of a viscoelastic surfactant (VES) gelled aqueous fluid with a first oil-based internal breaker where at least a portion of the first VES micelles are converted into second VES micelles to form an in situ microemulsion downhole.

### BACKGROUND

One of the primary methods for well stimulation in the production of hydrocarbons is hydraulic fracturing. Hydraulic fracturing is a method of using pump rate and hydraulic pressure to fracture or crack a subterranean formation. Once the crack or cracks are made, high permeability proppant, relative to the formation permeability, is pumped into the fracture to prop open the crack. When the applied pump rates and pressures are reduced or removed from the formation, the crack or fracture cannot close or heal completely because the high permeability proppant keeps the crack open. The propped crack or fracture provides a high permeability path connecting the producing wellbore to a larger formation area to enhance the production of hydrocarbons.

The development of suitable fracturing fluids is a complex art because the fluids must simultaneously meet a number of conditions. For example, they must be stable at high temperatures and/or high pump rates and shear rates that can cause the fluids to degrade and prematurely settle out the proppant before the fracturing operation is complete. Various fluids have been developed, but most commercially used fracturing fluids are aqueous based liquids that have either been gelled or foamed. When the fluids are gelled, typically a polymeric gelling agent, such as a solvatable polysaccharide, for example guar and derivatized guar polysaccharides, is used. The thickened or gelled fluid helps keep the proppants within the fluid. Gelling can be accomplished or improved by the use of crosslinking agents or crosslinkers that promote crosslinking of the polymers together, thereby increasing the viscosity of the fluid. One of the more common crosslinked polymeric fluids is borate crosslinked guar.

The recovery of fracturing fluids may be accomplished by reducing the viscosity of the fluid to a low value so that it may flow naturally from the formation under the influence of formation fluids. Crosslinked gels generally require viscosity breakers to be included to reduce the viscosity or “break” the gel. Enzymes, oxidizers, and acids are known polymer viscosity breakers. Enzymes are effective within a pH range, typically a 2.0 to 10.0 range, with increasing activity as the pH is lowered towards neutral from a pH of 10.0. Most conventional borate crosslinked fracturing fluids and breakers are designed from a fixed high crosslinked fluid pH value at ambient temperature and/or reservoir temperature. Optimizing the pH for a borate crosslinked gel is important to achieve proper crosslink stability and controlled enzyme breaker activity.

While polymers have been used in the past as gelling agents in fracturing fluids to carry or suspend solid particles as noted, such polymers require internal breaker compositions to reduce the viscosity. Further, such polymers tend to leave a coating on the proppant and a filter cake of dehydrated polymer on the fracture face even after the gelled fluid is broken. The coating and/or the filter cake may interfere with the functioning of the proppant. Studies have also shown that “fish-eyes” and/or “microgels” present in some polymer gelled carrier fluids will plug pore throats, leading to impaired leakoff and causing formation damage.

Recently it has been discovered that aqueous drilling and treating fluids may be gelled or have their viscosity increased by the use of non-polymeric viscoelastic surfactants (VES). These VES gelling materials are advantageous over the use of polymer gelling agents, since they are low molecular weight surfactants, in that they are less damaging to the formation, without a fluid-loss additive present leaves no filter cake on the formation face, leave very little coating on the proppant, and do not create microgels or “fish-eyes”. Progress has also been made toward developing internal breaker systems for the non-polymeric VES-based gelled fluids, that is, breaker systems that use products that are incorporated and dispersed and/or solubilized within the VES-gelled fluid that are activated by downhole conditions that will allow a controlled rate of gel viscosity reduction, for example over a rather short period of time of 1 to 24 hours or so, similar to gel break times common for conventional crosslinked polymeric fluid systems.

Furthermore, although VES-gelled fluids are an improvement over polymer-gelled fluids from the perspective of being easier to clean up the residual gel materials after the fluid viscosity is broken and the fluid produced or flowed back, improvements need to be made in cleaning-up from operations employing VES-gelled fluids.

It would be desirable if clean-up methods could be devised to more completely and easily remove well completion fluids gelled with and composed of viscoelastic surfactants, particularly the remnants or deposits left by such fluids.

### SUMMARY

There is provided, in one form, a method for generating an in situ microemulsion downhole. The viscosity of a gelled aqueous fluid may be broken with a first oil-based internal breaker where the broken gelled aqueous fluid may include spherical micelles, a first oil-based internal breaker, and an additional component. The additional component may be or include, but is not limited to a second oil-based internal breaker, a clean-up agent, an emulsifying agent, and combinations thereof.

An in situ microemulsion may form downhole where the in situ microemulsion may include at least the spherical micelles, the first oil-based internal breaker, and the additional component. The in situ microemulsion may perform a function, such as increasing the rate of flowback of an internally broken VES treatment fluid, increasing the volume of treatment fluid recovered, increasing the relative permeability of a hydrocarbon stream, e.g. oil, gas, and the like; decreasing water saturation of a hydrocarbon stream, reducing capillary pressure and water-block in the reservoir, enhancing the solubilization and dispersion of viscoelastic surfactant molecules, enhancing the solubilization and dispersion of internal breakers and/or internal breaker by-products when breaking a VES gel, reducing the interfacial tension at the rock-fluid interface, reducing the contact angle at the rock-fluid interface, reducing the water/oil interfacial tension, keeping the reservoir surfaces water-wet, and combinations thereof.

There is provided in another non-limiting embodiment, a method for generating in situ an in situ microemulsion by breaking a viscoelastic surfactant (VES) gelled aqueous fluid with a first oil-based internal breaker. Upon breaking of the gelled aqueous fluid, at least a portion of a plurality of first VES micelles (e.g. wormlike micelle structures) are converted into second VES micelles, and an in situ microemulsion may form downhole with at least a portion of the second VES micelles and with at least a portion of the first oil-based internal breaker. The in situ microemulsion may perform a function, such as but not limited to, increasing the rate of flowback of an internally broken VES treatment fluid, increasing the volume of treatment fluid recovered, increasing the relative permeability of a hydrocarbon stream, e.g. oil, gas, and the like; decreasing water saturation of a hydrocarbon stream, reducing capillary pressure and water-block in the reservoir, enhancing the solubilization and dispersion of viscoelastic surfactant molecules, enhancing the solubilization and dispersion of internal breakers and/or internal breaker by-products when breaking a VES gel, reducing the interfacial tension at the fluid-rock interface, reducing the contact angle at the rock-fluid interface, reducing the water/oil interfacial tension, keeping the reservoir surfaces water-wet, and combinations thereof.

There is provided, in another form, an in situ microemulsion generated downhole that may include at least a portion of a broken gelled aqueous fluid having a plurality of second VES micelles and a hydrocarbon fluid. The broken gelled aqueous fluid may include at least a portion of the second VES micelles, a first oil-based internal breaker, and an additional component, such as but not limited to a second oil-based internal breaker, a clean-up agent, an emulsifying agent, and combinations thereof.

There is provided, in another form, an in situ microemulsion generated downhole having at least a portion of second VES micelles and a hydrocarbon fluid. The second VES micelles may have been converted from a plurality of first VES micelles. The hydrocarbon fluid may combine with at least a portion of the second VES micelles to form the in situ microemulsion.

The in situ microemulsion that forms downhole allows for one VES gelled aqueous fluid to be pumped or injected downhole and have multiple purposes, such as but not limited to assisting with fracturing of the formation and/or subsequent clean-up of the VES gelled fluid once it is no longer needed, and the like.

### BRIEF DESCRIPTION OF THE DRAWINGS

FIG. 1 is schematic diagram and a graph illustrating the comparison of the percent return permeability of two core samples where only one was pre-cleaned with a microemulsion;

FIG. 2 is a graph illustrating the compatibility of several types of mineral oil in Aromox APA-T, a viscoelastic surfactant distributed by AkzoNobel, over a period of time at 100° F.;

FIG. 3 is a graph illustrating the compatibility of several types of mineral oil in Aromox APA-T over a period of time at 250° F.; and

FIG. 4 is a photograph illustrating a plurality of VES fracturing fluids being broken and subsequently forming a respective microemulsion.

### DETAILED DESCRIPTION

It has been discovered that an in situ microemulsion may be generated downhole once a viscoelastic surfactant (VES) gelled aqueous fluid has been broken. The VES gelled fluid may have a plurality of first VES micelles, e.g. surfactants arranged to have wormlike or elongated micelle structures, where at least a portion of the first VES micelles are converted into second VES micelles, e.g. surfactants arranged to have spherical micelle structures, upon breaking viscosity of the VES gelled fluid. Converting the first VES micelles into the second VES micelles may occur by a method, such as but not limited to rearranging, degrading, or another method known to those skilled in the art whereby the shape and/or functionality of the micelles are different between the first VES micelle and the second VES micelle. The broken gelled aqueous fluid may include at least a portion of the second VES micelles, e.g. spherical micelles in one non-limiting example, and a first oil-based internal breaker.

The VES gelled aqueous fluid may also include an oil-based internal breaker. The oil-based internal breaker may cause the viscosity of the VES to decrease, and the worm-like structure (e.g. first VES micelle) may change into the spherical VES micelle (e.g. second VES micelle). When a micelle-to-micelle (MME) agent is introduced into the VES gelled aqueous fluid, the MME agent may not initially affect the viscous VES micelle, but upon breaking of the VES fluid by the internal breaker, the MME agent may be incorporated into the spherical micelles (e.g. second VES micelle), along with remnants of the oil-based internal breaker. The spherical micelles (e.g. second VES micelles) may improve the composition and fluid properties of the in situ microemulsion for fluid cleanup within the reservoir.

The spherical micelles, the first oil-based internal breaker, and one or more optional additional components may form the in situ microemulsion downhole. The in situ formed microemulsion has improved and/or optimized cleanup properties when compared to a VES gelled aqueous fluid having only an internal breaker therein for purposes of reducing fluid viscosity and thereby treatment fluid cleanup of the broken VES gelled aqueous fluid. Moreover, the in situ formed microemulsion may develop at the location of the broken VES gelled aqueous fluid for better removal of the broken VES gelled aqueous fluid by the in situ formed microemulsion.

The in situ microemulsion cleanup fluid is particularly effective in unconsolidated reservoirs, and unconventional ultra-low permeability reservoirs. The formation of the in situ microemulsion from the viscous VES treatment fluid still allows for VES treatment fluid to be pumped downhole into a subterranean formation for traditional uses of the VES treatment fluid, such as gravel packing, frac-packing, hydraulic fracturing, fluid loss pill, and the like. Once the viscosity of the VES treatment fluid is reduced by at least one internal breaker, the in situ formation of the microemulsion may subsequently occur.

A “gelled aqueous fluid” is an aqueous fluid that has been viscosified or gelled by the VES. A VES when placed in select brine arranges into wormlike micelle structures that overlap and entangle to impart fluid viscosity. Therefore, a “broken gelled aqueous fluid” occurs when the viscosity of at least a portion of the gelled aqueous fluid has been reduced and is no longer gelled.

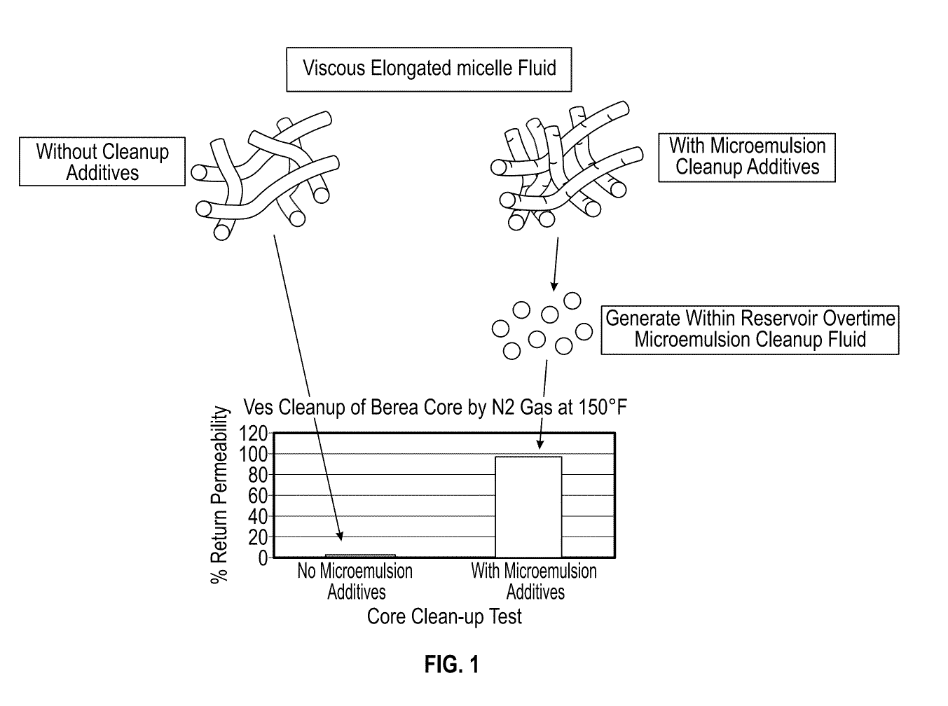

The first VES micelles within the VES gelled aqueous fluid may be elongated (e.g. wormlike) micelles, such as shown as micelles 10, 12 in FIG. 1. Said differently, the plurality of first VES micelles (e.g. elongated micelles 10, 12) may be pumped downhole, and at least a portion of the first VES micelles may be later converted into second VES spherical micelles 16. ‘First VES micelles’ as defined herein refers to the elongated micelles 10, 12, and ‘second VES micelles’ as defined herein refers to the spherical micelles 16. ‘Spherical’ is defined herein to include micelles having a substantially round shape if not a true sphere. The VES may be or include, but is not limited to, an amine oxide, a betaine, a quaternary amine, a sarcosinate, and combinations thereof. In one non-limiting explanation, the elongated micelles 10, 12 are believed to impart viscosity to the aqueous fluid in which they reside by physical entanglement with one another as shown in groups 14 of FIG. 1. In a non-limiting embodiment, the first VES micelles may require two or more organic agents differing in charge in order to form, such as but not limited to cationic agents like trimethyl-octadecammonium chloride with anionic agents like sodium xylene sulfonate as described in U.S. Pat. No. 6,468,945, which is herein incorporated by reference in its entirety. In another non-limiting embodiment, single surfactant gelled fluids require counterions to form wormlike micelles, such as but not limited to salts like KCl, CaCl₂, and the like.

The additional component may be or include, but is not limited to a second oil-based internal breaker, a clean-up agent, an emulsifying agent, and combinations thereof. The additional component(s) may be part of the VES gelled aqueous fluid system pumped downhole.

More particularly, it has been discovered that an in situ microemulsion with a modifiable composition may be used to aid the removal of broken VES gelled aqueous fluids. By “modifiable” it is meant that the in situ microemulsion may have its components and proportion of components changed or formulated to fit a particular application, VES-gelled fluid, reservoir hydrocarbon, and/or conditions encountered in the subterranean formation. The modifiable components that may be changed or selectively formulated include oil-based internal breakers, cleanup agents, emulsifying agents, and combinations thereof. In particular, the in situ microemulsion and methods discussed may be used with micelle rearranging chemistries, such as Saponification breaker systems, Mineral oil breaker systems, and Polyenoic breaker systems.

Saponification breaker systems involve the use of a soap reaction product of a fatty acid with an alkali or alkali earth metal base, such as described in issued U.S. Pat. No. 7,728,044, which is herein incorporated by reference in its entirety. Polyenoic breaker systems involve an unsaturated fatty acid (e.g. a polyenoic acid), further comprising heating the fluid to a temperature effective to cause the unsaturated fatty acid to produce products in an amount effective to reduce the viscosity of the gelled aqueous fluid such as described in issued U.S. Pat. No. 7,645,724, which is herein incorporated by reference in its entirety. In one non-limiting embodiment, the unsaturated fatty acid used as part of a polyenoic breaker system is different from the unsaturated fatty acid used as the viscosity reducing agent. Natural oils such as soybean oil, corn oil, canola oil, salmon oil, and the like are primarily composed of mono-, di- and triglycerides, and natural oils vary in amount of saturated and unsaturated fatty acids.

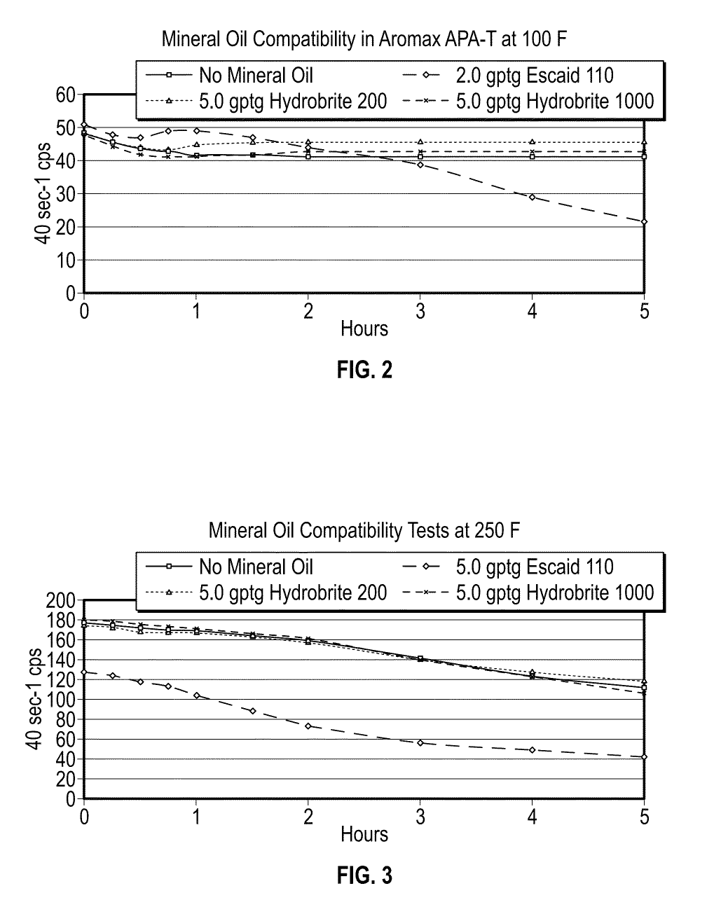

Mineral oil breaker systems involve the use of refined paraffinic hydrocarbons with higher molecular weight and/or viscosity, such as described in issued U.S. Pat. No. 7,343,266, which is herein incorporated by reference in its entirety. Select types of mineral oils slowly become soluble and/or dispersible in surfactant-laden VES-gelled fluid over time at elevated fluid temperature. Typically the high viscosity mineral oils may not break the viscosity of VES gelled fluid (e.g. degrade wormlike micelle structures) at low temperatures such as 100° F., as the Hydrobrite 200 and Hydrobrite 1000 mineral oil data shows in FIG. 2 (discussed in more detail below). The higher molecular weight mineral oil products may also have slow or limited effect on VES-gelled fluid viscosity at 250° F. fluid temperatures over time, as shown in FIG. 3 (also discussed in more detail below).

The use of the in situ microemulsion will aid in one or more of the following functions and processes: increasing the rate of flowback of an internally broken VES treatment fluid; increasing the volume of treatment fluid recovered, increasing the relative permeability of a hydrocarbon stream, e.g. oil, gas, and the like by decreasing water saturation in the pores, primary fractures, and/or near-wellbore and far-field complex hydraulic fractures network; reducing the capillary pressure in the reservoir; reducing the amount of treatment fluid induced capillary pressure and water-block in the reservoir; enhancing the solubilization and dispersion of intact and/or converted viscoelastic surfactant molecules; enhancing the solubilization and dispersion of internal breakers and/or internal breaker by-products generated when breaking the VES gel; reducing the surface tension at the fluid-rock interface; reducing the contact angle at the fluid-rock interface; reducing the roll-off angle adhesion property at the fluid-rock interface; reducing the aqueous treatment fluid/formation oil interfacial tension; and/or keeping the reservoir surfaces water-wet.

The cleanup performance or improvement of an internal breaker viscosity broken VES treatment fluid in many cases may be optimized through a laboratory test. Formulation science may be used by one skilled in the art to include select type(s) and/or amount(s) of cleanup agents that may have a limited influence on the initial viscosity of the VES gelled treatment fluid, but the inclusion of such cleanup agents may enhance the cleanup performance. Laboratory tests, such as surface tension, interfacial tension, contact angle, roll-off angle, and the like may be measured for optimizing the cleanup properties of the internally broken VES treatment fluid.

It should be noted that change in only one fluid property, such as surface tension, may not characterize the degree of cleanup performance expected, but that other fluid properties, such as fluid-rock contact angle, fluid-rock roll-off angle, fluid-fluid interfacial tension, and the like may better indicate the cleanup performance of the internally broken VES treatment fluid. Measurements related to surface tension and/or contact angle, may allow for better selection and optimization of particular agents within a particular VES treatment fluid related to anticipated reservoir conditions. However, laboratory measurements of only one fluid property, such as surface tension or contact angle, may not provide sufficient information for formulation of the most optimized in situ microemulsion cleanup fluid upon internal breaking of the VES gel treatment fluid in the reservoir. For example, it is well known to those skilled in the art that contact angle, alone, may not quantify the resistance or ease of liquid motion or flow in the direction tangential to the rock surface.

It will also be appreciated that one skilled in the art of formulation can develop a robust viscosity VES fluid for treatments like hydraulic fracturing for a particular bottom hole static temperature (BHST) by using a laboratory rheometer and determining the right type and amount of MME agents to be included for improving the reservoir and flowback properties. That is, after the VES gelled treatment fluid is pumped for a treatment, particular properties may be improved over time, while the VES gelled treatment fluid is within the reservoir. Such properties may be or include, but are not necessarily limited to, surface tension, contact angle, roll-off angle, and other adhesion, adsorption, capillary force, and the like. The ability to create a microemulsion cleanup fluid in situ downhole by careful formulation and use of MME agents further advances the clean-breaking polymer-free characteristics of VES fluids for reducing and/or eliminating formation damage caused by traditional polymeric treatment fluids.

Additives that may be beneficial to the in situ microemulsion described are described in U.S. Pat. No. 7,655,603, which is herein incorporated by reference in its entirety. Previously, viscosity generators, viscosity enhancers, and internal breakers, were added to VES-gelled fluids for purposes of generating, increasing, or decreasing the viscosity of VES wormlike micelles downhole. Internal breakers were only used for improving VES treatment fluid cleanup by lowering and/or substantially reducing the viscosity of the VES fluid. However, the in situ microemulsion described uses select materials and processes as a means for manufacturing a microemulsion fluid downhole with improved reservoir cleanup capability.

In the past, internal breakers were developed solely for purposes of reducing VES-fluid viscosity as a mechanism of improving treatment fluid flowback from the treated reservoir. Internal breakers were not selected as a component of the final flowback fluid composition. VES-gelled treatment fluid may now be created to form an in situ microemulsion cleanup fluid with improved cleanup performance such that the total properties of the microemulsion cleanup fluid is greater than its individual parts. That is, an improved use of micelle to micelle engineering (i.e. wormlike micelle structure to spherical micelle structure) is presented. First VES micelles may be formulated for a first use, such as hydraulic fracturing at elevated temperature, and the conversion from the first VES micelles into second VES micelles may be controlled by internal breakers. During the generation of the second VES micelles, the selectively chosen cleanup agents, emulsifying agents, oil-based internal breaking agents, and/or any other additives may be present to aid in chemical modification of the second VES micelles to form the in situ microemulsion cleanup fluid with improved reservoir cleanup properties.

There has developed a need for this type of chemical preventative and remediation technology. There are treatment cases that show problems with VES gel clean-up after a treatment, such as where the VES treatment fluid does not readily or completely flow back during reservoir production. To this point, common use of expensive pre-flush and post-flush VES clean-up fluids have been used or remedial VES clean-up fluids have been used when flow back shows reservoir impairment after a VES treatment. The use of internal breakers in VES-gelled fluids helps to reduce fluid viscosity, which increases treatment fluid recovery. The type and/or amount of VES may provide beneficial surface tension and capillary pressure reduction between the reservoir rock and treatment fluid to further aid treatment fluid cleanup. However, changing the broken VES gelled fluid into a cleanup fluid, while in the formation, may significantly improve VES-gelled treatment fluid recovery, particularly where residual permeability damage has been done to the reservoirs by the broken VES gelled fluid. Formulation science may be used to determine the optimum combination of correct proportion of components for use of the fluid as a VES gelled fluid, breaking the gelled fluid, and subsequently using the broken VES gelled fluid to form an in situ microemulsion for clean-up purposes.

In situ microemulsions may be developed from the broken VES gelled fluids where the in situ microemulsion may enhance treatment fluid cleanup for improved reservoir production of a hydrocarbon stream, such as gas, oil and the like. Microemulsions are liquid mixtures of oil, water, surfactant, and may include a co-surfactant different from the viscoelastic surfactant, a co-solvent, and the like. In the context of the in situ microemulsions, it is not necessary that the in situ microemulsions be clear or transparent. For oil-in-water microemulsion formulations, it is not necessary that the all of the oil is completely solubilized in the water and the second VES micelles; that is, it is permissible where only a portion of the oil is dispersed within the water phase and the second VES micelles. The portion of the oil dispersed within the water phase may be nanometer and/or micrometer diameter droplets. A nanometer is defined herein as 10⁻⁹ meter or nm, and a micrometer is defined herein as 10⁻⁶ meter or μm.

The first VES gelled aqueous fluid may be pumped downhole with at least a first oil-based internal breaker. As the first oil-based internal breaker reduces the viscosity of the first VES gelled fluid, at least a portion of the first VES micelles may be converted and/or rearranged into second VES micelles having a relatively spherical structure. During the micelle conversion process, the in situ microemulsion is generated for additional clean-up of the broken VES gelled aqueous fluid from the treated reservoir.

The cleanup agent may be or include, but is not limited to, a surfactant, a polyol, a solvent, a polymeric surfactant, and combinations thereof. The surfactants may be cationic surfactants, anionic surfactants, non-ionic surfactants, amphoteric surfactants, and combinations thereof. The cationic surfactants may be amide ethoxylates, amine ethoxylates, diamine ethoxylates, polyamines ethoxylates, quaternary ammonium salts, and the like. Non-limiting examples of anionic surfactants may be alkyl sulfates, alkyl ether sulfates, alkyl sulfonates, aryl sulfonates, alkyl aryl sulfonates, perfluoroalkyl sulfonates, mono- and di-alkyl sulfosuccinates, alkyl phosphate esters, ethoxylated alkyl phosphate esters, alkyl ether phosphate esters, and the like. Non-ionic surfactants may be alkyl ethoxylates, fatty alcohol ethoxylates, amine oxides, ethoxylated amine oxides, alkoxylated plant oils, ethoxylated plant oils, alkyl polyglucosides, and the like. The amphoteric surfactants can be betaines, amidobetaines, alkyl amphodiacid salts.

The polyols may be or include, but are not limited to, glycerol, ethylene glycols, propylene glycols, sugar alcohols, and the like. The solvents may be alcohols, glycol ethers, pyrrolidones, and the like. The polymeric surfactants may be sulfonated copolymers, sulfonated polystyrene, EO-PO-EO polymers, and the like.

The concentration of the cleanup agent or combination of cleanup agents within the VES gelled aqueous fluid may range from about 0.001% by volume independently to about 6% by volume in one non-limiting embodiment, alternately from about 0.01% by volume independently to about 2% by volume, or from about 0.1% by volume independently to about 1.5% by volume in another alternative embodiment. As used herein with respect to a range, “independently” means that any lower threshold may be used together with any upper threshold to give a suitable alternative range.

The emulsifying agent may be or include, but is not limited to, surfactants, polymers, oils, and combinations thereof. The surfactants may be or include, but are not limited to cationic surfactants, anionic surfactants, non-ionic surfactants, and combinations thereof. The cationic surfactants may be or include, but are not limited to, fatty amines, fatty alkyl diamines, fatty alkyl polyamines, alkyl and di-alkyl ammonium salts, alkyl aryl ammonium salts, and the like. The anionic surfactants may be or include, but are not limited to, fatty acids, fatty acid salts, alkyl aryl sulfonates, and the like. The non-ionic surfactants may be or include, but are not limited to, plant oil ethoxylates, nonylphenol ethoxylates, fatty alcohols, fatty alcohol ethoxylates, fatty alcohol alkoxylates, sorbitan esters, sorbitan ester ethoxylates, and the like. The emulsifying type polymers may be or include, but are not limited to co-polymers, ethoxylated co-polymers, resins, and combinations thereof. The oils may be or include, but are not limited to terpenes, dicarboxylic acid esters, mineral oils, plant and animal oils, hydrogenated plant and animal oils, refined and/or fractionated plant and animal oils, and combinations thereof.

The amount of the emulsifying agent(s) within the VES gelled aqueous fluid may range from about 0.001% by volume independently to about 4% by volume, alternatively from about 0.005% by volume independently to about 1% by volume, or from about 0.01% by volume independently to about 0.5% by volume in another non-limiting embodiment. One non-limiting embodiment of the in situ microemulsion may have the following components:
1. At least a portion of the spherical micelles; and
2. a first oil-based internal breaker;
   and the following optional components: a. a second oil-based internal breaker that breaks the VES gelled fluid at a slower rate than the first oil-based internal breaker; b. a clean-up agent; and/or c. an emulsifying agent.

In an alternative non-restrictive embodiment, the in situ microemulsion may have the following components:
1. At least a portion of the spherical micelles;
2. a first oil-based internal breaker; and
3. a second oil-based internal breaker that breaks the first VES gelled aqueous fluid at a slower rate than the first oil-based internal breaker;
   and the following optional components: a. a clean-up agent; and/or b. an emulsifying agent.

In another non-limiting embodiment, the in situ microemulsion may have the following components:
1. At least a portion of the spherical micelles;
2. a first oil-based internal breaker; and
3. a clean-up agent;
   and the following optional components: a. a second oil-based internal breaker that breaks the first VES gelled aqueous fluid at a slower rate than the first oil-based internal breaker; and/or b. an emulsifying agent.

In another non-limiting embodiment, the in situ microemulsion may have the following components:
1. At least a portion of the broken VES having spherical micelles;
2. a first oil-based internal breaker that continues breaking the VES gelled fluid; and
3. an emulsifying agent;
   and the following optional components: a. a clean-up agent; and/or b. a second oil-based internal breaker that breaks the first VES gelled aqueous fluid at a slower rate than the first oil-based internal breaker.

In one non-limiting embodiment, the VES spherical micelles, first oil-based internal breakers, and the optional additional components may be formulated to mix with the reservoir hydrocarbon fluid to generate the in situ microemulsion. However, the hydrocarbon fluid may not be required to form the in situ microemulsion downhole.

The amounts of the components within the in situ microemulsion may vary. For example, the spherical micelles within the in situ microemulsion may range from about 0.4% by volume independently to about 10% by volume, alternatively from about 0.6% by volume independently to about 8% by volume, or from about 0.8% by volume independently to about 6% by volume in another non-limiting example.

The amount of the first oil-based internal breaker within the in situ microemulsion may range from about 0.05% by volume independently to about 2% by volume of the in situ microemulsion, alternatively from about 0.1% by volume independently to about 1.5% by volume, or from about 0.2% by volume independently to about 1% by volume in another non-limiting embodiment. As used herein with respect to a range, “independently” means that any lower threshold may be used together with any upper threshold to give a suitable alternative range.

The first oil-based internal breaker and/or the second oil-based internal breaker may be or include, but is not limited to, mineral oil, natural oil, and combinations thereof. The natural oil may be or include refined natural oils and blends of natural oils, such as but not limited to fish oil, soybean oil, corn oil, flax oil, and combinations thereof. Specific non-limiting examples of the natural oils may be or include Fish Oil E3322, Fish Oil 1812TG, Salmon Oil 6:9, Tuna Oil 6:25, Primrose Oil 9%, Borage Oil 22%, Black Currant Oil 15%, and combinations thereof, all of which are distributed by BIORIGINAL™.

The second oil-based internal breaker may break the viscosity of the VES gelled aqueous fluid at a slower rate than the first oil-based internal breaker. For example, the first oil-based internal breaker may be a Fish Oil 18:12TG, and the second oil-based internal breaker may be soybean oil where the soybean oil breaks the viscosity of the VES gelled aqueous fluid at a slower rate than the fish oil. Fish Oil 18:12TG is an omega-3 product and has approximately 18% eicosapentaenoic acid (5 double carbon bond fatty acid) and 12% docosahexaenoic acid (6 double carbon bond fatty acid).

In one non-limiting embodiment, there may be more than two oil-based internal breakers, such as up to about 4 oil-based internal breakers. If the oil-based internal breaker is a mineral oil, it may have a viscosity ranging from about 0.5 cps independently to about 120 cps, alternatively from about 3 cps independently to about 80 cps, or from about 4 cps independently to about 60 cps. The natural oil-based internal breakers may also be referred to as having varying amounts of unsaturated fatty acids, and/or as autooxidation agents in that they will autooxidize into products that will reduce the viscosity of the VES-gelled aqueous fluids. Natural oils that contain highly unsaturated fatty acids, e.g. certain fish oils, will autooxidize faster than oils that contain mono-, di- and tri-unsaturated fatty acids, e.g. soybean oil, corn oil, etc. Natural oils will autooxidize significantly faster than oils that contain primarily mono-unsaturated fatty acids, e.g. olive oil and canola oils. Highly unsaturated fatty acids autooxidize at a faster rate than fatty acids that are less unsaturated. Therefore, the less unsaturated fatty acids typically remain as oil when breaking the viscosity of the VES gelled aqueous fluid and micelle conversion process, and subsequently may comprise all or part of the oil phase of the microemulsion.

In one non-limiting example, the natural oil used to break the VES-gelled fluid viscosity may be a 50/50 ratio of salmon oil and canola oil, where the canola oil remains an oil for a significantly longer period of time before degrading by autooxidation compared to the highly unsaturated fatty acid components in the salmon oil. TABLE 1 shows the relative rate of autooxidation for fatty acids depending on the number of carbon-carbon double bonds, i.e. the amount of unsaturation of the fatty acid.

TABLE 1
Relative Oxidation Rates of Some Common Fatty Acids

| Fatty | Total Amount of | Number of double carbon | Relative Rate |
|---|---|---|---|
| Acid | Carbon Atoms | bonds | of Oxidation |
| Stearic | 18 | 0 | 1 |
| Oleic | 18 | 1 | 100 |
| Linoleic | 18 | 2 | 1200 |
| Linolenic | 18 | 3 | 2500 |

TABLE 2 includes viscosity compatibility data with micelle-to-micelle (MME) engineering agents by indicating the viscosity of a particular formulation over time at 150° F. The base fluid was a 7% KCl brine and 4% Aromox APA-T.

TABLE 2
150° F. Compatibility of MME Agents

| | Temp | | | Viscosity (Cps @ 100 sec⁻¹) | | | | | |
|---|---|---|---|---|---|---|---|---|---|
| Test | (° F.) | MME Agent | Amount | 0.5 hrs | 1 hrs | 1.5 hrs | 2 hrs | 2.5 hrs | 3 hrs |
| 1 | 150 | None (Baseline | 0 | 125 | 127 | 126 | 128 | 127 | 128 |
| | | Viscosity) | | | | | | | |
| 2 | 150 | Armeen OLD | 3 gptg | 32 | 6 | 5 | 5 | 4 | 4 |
| 3 | 150 | Armeen OLD | 2 gptg | 81 | 47 | 27 | 21 | 18 | 15 |
| 4 | 150 | Armeen OLD | 1 gptg | 107 | 108 | 109 | 106 | 105 | 102 |
| 5 | 150 | Stepanate SXS | 3 gptg | 129 | 130 | 129 | 132 | 130 | 132 |
| 6 | 150 | Stepanate SXS | 5 gptg | 129 | 130 | 131 | 132 | 132 | 131 |
| 7 | 150 | Stepanate SXS | 10 gptg | 118 | 118 | 120 | 118 | 118 | 119 |
| 8 | 150 | ST-200EW | 6 gptg | 129 | 131 | 131 | 134 | 133 | 133 |
| 9 | 150 | ST-200EW | 10 gptg | 106 | 107 | 108 | 109 | 109 | 110 |
| 10 | 150 | Brimopol S-PE | 4 gptg | 131 | 130 | 131 | 132 | 132 | 133 |
| 11 | 150 | Brimopol S-PE | 6 gptg | 137 | 137 | 137 | 138 | 138 | 137 |
| 12 | 150 | Brimopol S-PE | 10 gptg | 149 | 150 | 148 | 150 | 149 | 151 |
| 13 | 150 | Stepanol WA- | 4 pptg | 124 | 123 | 123 | 123 | 125 | 126 |
| | | 100 NF/USP | | | | | | | |
| 14 | 150 | Stepanol WA- | 8 pptg | 124 | 122 | 125 | 125 | 124 | 125 |
| | | 100 NF/USP | | | | | | | |
| 15 | 150 | NANSA HS | 4 pptg | 123 | 123 | 123 | 124 | 125 | 125 |
| | | 90/S | | | | | | | |
| 16 | 150 | NANSA HS | 8 pptg | 125 | 126 | 127 | 126 | 127 | 123 |
| | | 90/S | | | | | | | |
| 17 | 150 | Aromox C/12 | 3 gptg | 131 | 135 | 135 | 135 | 134 | 135 |
| 18 | 150 | Aromox C/12 | 5 gptg | 140 | 136 | 139 | 141 | 140 | 139 |
| 19 | 150 | Aromox C/12 | 10 gptg | 155 | 154 | 154 | 154 | 154 | 155 |
| 20 | 150 | Ethomeen C/12 | 3 gptg | 8 | 6 | 5 | 5 | 5 | 5 |
| 21 | 150 | Ethomeen C/12 | 1 gptg | 120 | 121 | 121 | 121 | 122 | 122 |
| 22 | 150 | Ethomeen C/12 | 2 gptg | 16 | 10 | 9 | 8 | 7 | 7 |
| 23 | 150 | Aromox DMC | 5 gptg | 136 | 136 | 137 | 137 | 136 | 137 |
| 24 | 150 | Aromox DMC | 10 gptg | 98 | 96 | 98 | 98 | 100 | 99 |
| 25 | 150 | Aromox DMC | 3 gptg | 127 | 133 | 133 | 132 | 133 | 133 |
| 26 | 150 | Ammonyx CDO | 3 gptg | 116 | 115 | 116 | 121 | 119 | 119 |
| | | Special | | | | | | | |
| 27 | 150 | Ammonyx CDO | 5 gptg | 103 | 104 | 104 | 105 | 106 | 106 |
| | | Special | | | | | | | |
| 28 | 150 | Ammonyx CDO | 10 gptg | 60 | 59 | 60 | 59 | 59 | 50 |
| | | Special | | | | | | | |
| 29 | 150 | Amphosol CA | 3 gptg | 113 | 115 | 115 | 114 | 115 | 116 |
| 30 | 150 | Amphosol CA | 10 gptg | 63 | 62 | 63 | 64 | 65 | 65 |

TABLE 3 includes viscosity compatibility data with micelle-to-micelle (MME) engineering agents by indicating the viscosity of a particular formulation over time at 250° F. The base fluid had 14.2 pounds per gallon (ppg) of a CaBr₂ brine and 5% Aromox APA-T+6 pounds per thousand gallons (VES-1).

TABLE 3
250° F. Compatibility of MME Agents

| | Temp | | | Viscosity (Cps @ 100 sec⁻¹) | | | | | |
|---|---|---|---|---|---|---|---|---|---|
| Test | (° F.) | MME Agent | Amount | 0.5 hrs | 1 hrs | 1.5 hrs | 2 hrs | 2.5 hrs | 3 hrs |
| 1 | 250 | None | 0 | 229 | 226 | 229 | 235 | 235 | 231 |
| | | (Baseline | | | | | | | |
| | | Viscosity) | | | | | | | |
| 2 | 250 | Armeen OLD | 3 gptg | 61 | 53 | 54 | 54 | 55 | 55 |
| 3 | 250 | Armeen OLD | 1 gptg | 232 | 233 | 235 | 232 | 234 | 235 |
| 4 | 250 | Armeen OLD | 2 gptg | 210 | 207 | 205 | 197 | 194 | 190 |
| 5 | 250 | Stepanate | 5 gptg | 193 | 202 | 194 | 195 | 194 | 198 |
| | | SXS | | | | | | | |
| 6 | 250 | Stepanate | 10 gptg | 165 | 160 | 159 | 162 | 164 | 167 |
| | | SXS | | | | | | | |
| 7 | 250 | ST-200EW | 10 gptg | 40 | 40 | 46 | 49 | 49 | 50 |
| 8 | 250 | ST-200EW | 5 gptg | 110 | 118 | 120 | 123 | 125 | 130 |
| 9 | 250 | Brimopol S- | 10 gptg | 212 | 215 | 221 | 217 | 213 | 220 |
| | | PE | | | | | | | |
| 10 | 250 | Brimopol S- | 5 gptg | 214 | 214 | 216 | 221 | 225 | 222 |
| | | PE | | | | | | | |
| 11 | 250 | Aromox C/12 | 10 gptg | 145 | 151 | 154 | 156 | 163 | 168 |
| 12 | 250 | Aromox C/12 | 5 gptg | 192 | 197 | 195 | 196 | 201 | 196 |
| 13 | 250 | Ethomeen | 2 gptg | 227 | 230 | 228 | 233 | 236 | 238 |
| | | C/12 | | | | | | | |
| 14 | 250 | Ethomeen | 3 gptg | 232 | 231 | 226 | 226 | 227 | 232 |
| | | C/12 | | | | | | | |
| 15 | 250 | Ethomeen | 5 gptg | 156 | 152 | 141 | 133 | 122 | 108 |
| | | C/12 | | | | | | | |
| 16 | 250 | Aromox DMC | 5 gptg | 152 | 152 | 160 | 165 | 164 | 168 |
| 17 | 250 | Aromox DMC | 3 gptg | 189 | 192 | 188 | 196 | 193 | 196 |
| 18 | 250 | Ammonyx | 5 gptg | 159 | 164 | 167 | 167 | 171 | 173 |
| | | CDO Special | | | | | | | |
| 19 | 250 | Ammonyx | 3 gptg | 182 | 186 | 187 | 193 | 196 | 202 |
| | | CDO Special | | | | | | | |
| 20 | 250 | Amphosol CA | 5 gptg | 148 | 154 | 158 | 167 | 167 | 170 |
| 21 | 250 | Amphosol CA | 10 gptg | 62 | 71 | 72 | 73 | 71 | 72 |
| 22 | 250 | Amphosol CA | 3 gptg | 175 | 186 | 185 | 192 | 190 | 195 |

TABLE 4 displays the formulation of each sample referred to in Tables 5-9; the listed sample number in TABLES 5-9 corresponds with the specific sample number noted in TABLE 4 below. The base fluid for each sample was a 7% KCl brine; each sample differed by whether the sample included a 5% concentration of APA-TW, a breaker, an MME agent 1, an MME agent 2, and combinations thereof.

TABLE 4
MME In Situ Microemulsion Sample Formulations

| | | Breaker (Oil | | |
|---|---|---|---|---|
| Sample | Base Fluid | Phase) | MME Agent 1 | MME Agent 2 |
| 1 | DI water | — | — | — |
| 2 | 7% KCl brine | — | — | — |
| 3 | 7% KCl + 0.5% | — | — | — |
| | APA-TW | | | |
| 4 | 7% KCl + 5% | 1% Fish Oil | — | — |
| | APA-TW | 18:12 | | |
| 5 | 7% KCl + 5% | 1% Flax Oil | — | — |
| | APA-TW | | | |
| 6 | 7% KCl + 5% | 0.5% Fish Oil | 1% Aromox C/12 | — |
| | APA-TW | 18:12 | | |
| 7 | 7% KCl + 5% | 0.5% Fish Oil | 1% Aromox C/12 | 0.25% Span 80 |
| | APA-TW | 18:12 | | |
| 8 | 7% KCl + 5% | 1% Fish Oil | 1% Aromox C/12 | — |
| | APA-TW | 18:12 | | |
| 9 | 7% KCl + 5% | 1% Fish Oil | 1% Aromox C/12 | 0.25% Span 80 |
| | APA-TW | 18:12 | | |
| 10 | 7% KCl + 5% | 0.6% Flax | 0.5% Aromox DMC | — |
| | APA-TW | | | |
| 11 | 7% KCl + 5% | 0.6% Flax | 0.5% Aromox DMC | 0.5% Aromox C/12 |
| | APA-TW | | | |
| 12 | 7% KCl + 5% | 1% Fish Oil | 0.2% Witcolate LES- | — |
| | APA-TW | 18:12 | 60C | |
| 13 | 7% KCl + 5% | 1% Fish Oil | 0.4% Witcolate LES- | — |
| | APA-TW | 18:12 | 60C | |
| 14 | 7% KCl + 5% | 1% Fish Oil | 0.2% Witcolate LES- | 0.2% Witconate 90F |
| | APA-TW | 18:12 | 60C | |
| 15 | 7% KCl + 5% | 1% Fish Oil | 0.4% Witcolate LES- | 0.4% Witconate 90F |
| | APA-TW | 18:12 | 60C | |
| 16 | 7% KCl + 5% | 1% Fish Oil | 0.4% Witcolate LES- | 0.4% Genapol T-500P |
| | APA-TW | 18:12 | 60C | |
| 17 | 7% KCl + 5% | 1% Flax Oil | 1% Witcolate D-510 | — |
| | APA-TW | | | |
| 18 | 7% KCl + 5% | 1% Flax Oil | 1% Witcolate D-510 | 0.5% Witcolate LES- |
| | APA-TW | | | 60C |
| 19 | 7% KCl + 5% | 1% Flax Oil | 1% Witcolate D-510 | 0.5% Witcolate LES- |
| | APA-TW | | | 60C + |
| | | | | 0.5% Witconate 90F |
| 20 | 7% KCl + 5% | 1% Flax Oil | 1% Witcolate D-510 | 0.5% Aromox C/12 |
| | APA-TW | | | |
| 21 | 7% KCl + 5% | 1% Fish Oil | 1.0% Aromox DMC | — |
| | APA-TW | 18:12 | | |
| 22 | 7% KCl + 5% | 2% Fish Oil | 1% Witcolate D-510 | — |
| | APA-TW | 18:12 | | |
| 23 | 7% KCl + 5% | 2% Fish Oil | 1% Witcolate D-510 | 1.0% Witconate 90F |
| | APA-TW | 18:12 | | |
| 24 | 7% KCl + 5% | 1% Fish Oil | 1% Witcolate D-510 | 1.0% Witconate 1247H |
| | APA-TW | 18:12 | | |
| 25 | 7% KCl + 5% | 1% Flax Oil | 1.0% Aromox DMC | — |
| | APA-TW | | | |
| 26 | 7% KCl + 5% | 2% Flax Oil | 1% Witcolate D-510 | — |
| | APA-TW | | | |
| 27 | 7% KCl + 5% | 2% Flax Oil | 1% Witcolate D-510 | 1.0% Witconate 90F |
| | APA-TW | | | |
| 28 | 7% KCl + 5% | 1% Flax Oil | 1% Witcolate D-510 | 1.0% Witconate 1247H |
| | APA-TW | | | |
| 29 | 7% KCl + 5% | 2% Soybean Oil | 1% Witcolate D-510 | — |
| | APA-TW | | | |
| 30 | 7% KCl + 5% | 4% Soybean Oil | 1% Witcolate D-510 | — |
| | APA-TW | | | |

TABLE 5 displays the surface tension and contact angle for samples 1-20 after 72 hours. The surface tension for each sample varied, and the contact angle of each sample decreased over time. The decrease in contact angle indicates another important cleanup performance property of the sample over time.

TABLE 5
72 Hour Surface Tension & Contact Angle Results - Samples 1-20

| | | | ST | | | | | |
|---|---|---|---|---|---|---|---|---|
| | Breaker | | Sample | Surface | Contact Angle (72 Hour | | | |
| | (Oil | Class of | Volume | Tension | at 175° F.) | | | |
| Sample | Phase) | MME Agent | (μl) | (Pendant) | CA Volume (μl) | 0 minute | 1 minute | 2 minute |
| 1 | — | — | 12.5 | 72.4 | 2 | 35.8 | 32.3 | 30.6 |
| 2 | — | — | 12.5 | 73.0 | 2 | 37.3 | 34.7 | 32.9 |
| 3 | — | — | 6.5 | 33.8 | 2 | 32.0 | 27.9 | 26.3 |
| 4 | Fish Oil | — | 6.5 | 32.2 | 2 | 29.2 | 25.8 | 23.8 |
| | 18:12 | | | | | | | |
| 5 | Flax Oil | — | 6.25 | 32.1 | 2 | 28.3 | 25.8 | 24.2 |
| 6 | Fish Oil | Amine Oxide | 5.5 | 28.1 | 2 | 29.0 | 27.2 | 25.9 |
| | 18:12 | | | | | | | |
| 7 | Fish Oil | Amine Oxide | 5.75 | 28.8 | 2 | 32.4 | 30.3 | 28.6 |
| | 18:12 | & Sorbitan | | | | | | |
| 8 | Fish Oil | Amine Oxide | 6.25 | 30.0 | 2 | 24.8 | 23.0 | 21.6 |
| | 18:12 | | | | | | | |
| 9 | Fish Oil | Amine Oxide | 5.75 | 29.1 | 2 | 25.5 | 23.8 | 22.3 |
| | 18:12 | & Sorbitan | | | | | | |
| 10 | Flax Oil | Amine Oxide | 6.0 | 31.5 | 2 | 24.0 | 22.8 | 21.3 |
| 11 | Flax Oil | Amine Oxide | 6.0 | 29.6 | 2 | 24.4 | 22.5 | 21.3 |
| | | & Amine | | | | | | |
| | | Oxide | | | | | | |
| 12 | Fish Oil | Sulfate Ester | 5.75 | 29.3 | 2 | 34.4 | 32.2 | 30.5 |
| | 18:12 | | | | | | | |
| 13 | Fish Oil | Sulfate Ester | 5.75 | 29.1 | 2 | 34.4 | 31.9 | 30.2 |
| | 18:12 | | | | | | | |
| 14 | Fish Oil | Sulfate Ester | 5.75 | 28.7 | 2 | 33.9 | 31.6 | 30.1 |
| | 18:12 | & Sulfonate | | | | | | |
| 15 | Fish Oil | Sulfate Ester | 5.5 | 27.6 | 2 | 25.6 | 24.0 | 23.0 |
| | 18:12 | & Sulfonate | | | | | | |
| 16 | Fish Oil | Sulfate Ester | 6.25 | 30.2 | 2 | 32.0 | 29.9 | 28.5 |
| | 18:12 | & Non-ionic | | | | | | |
| 17 | Flax Oil | Sulfate | 5.5 | 28.4 | 2 | 18.1 | 16.4 | 16.6 |
| 18 | Flax Oil | Sulfate & | 5.5 | 27.4 | 2 | 23.7 | 22.2 | 21.2 |
| | | Sulfonate | | | | | | |
| 19 | Flax Oil | Sulfate & | 5.25 | 25.9 | 2 | 21.4 | 19.0 | 18.0 |
| | | Two | | | | | | |
| | | Sulfonates | | | | | | |
| 20 | Flax Oil | Sulfate & | 5.75 | 28.1 | 2 | 28.4 | 26.2 | 24.6 |
| | | Amine Oxide | | | | | | |

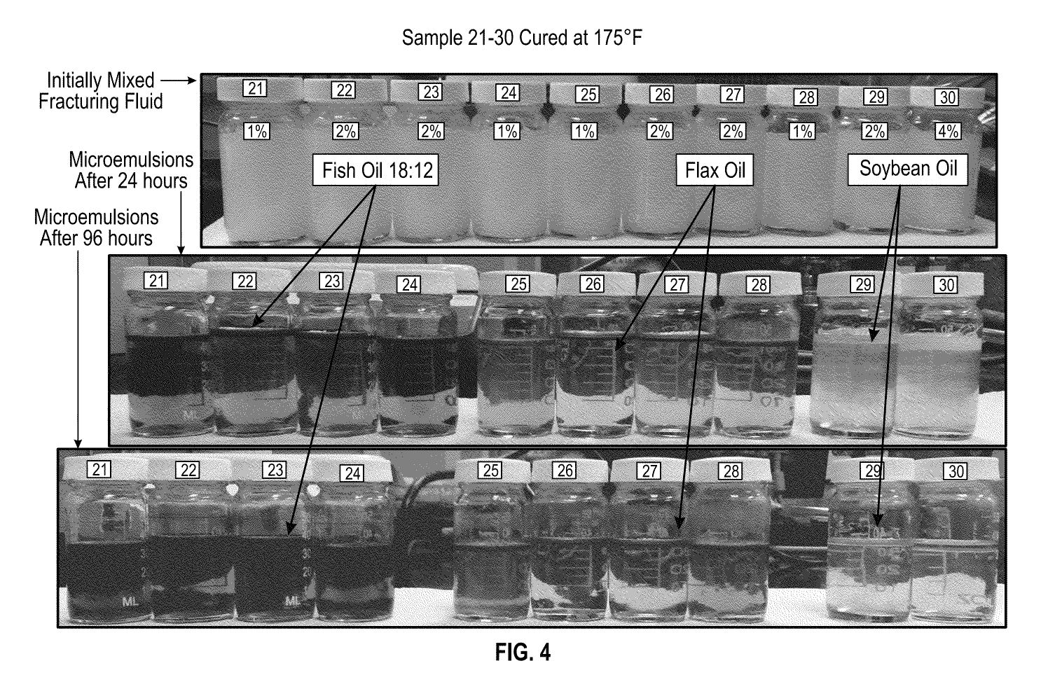

TABLE 6 displays the surface tension and contact angle of samples 4-5, and samples 21-30 after 24 hours. Samples 4 and 5 are noted here to compare the ability of the sample without an MME (samples 4 and 5) as compared to the samples with an MME (samples 21-30). Noted within TABLE 6, samples 29 and 30 did not have surface tension or contact angle measurements because the VES within the fluid was not sufficiently broken to take such measurements, which is also depicted in the photo of FIG. 4 in the middle row.

TABLE 6
24 Hour Surface Tension & Contact Angle Results - 21-30

| | Breaker | | | Contact Angle (24 Hours at | | | |
|---|---|---|---|---|---|---|---|
| | (Oil | Class of MME | Surface | 175° F.) | | | |
| Sample | Phase) | Agent | Tension | 0 minute | 1 minute | 2 minute | 3 minute |
| 4 | Fish Oil | — | 34.4 | | | | |
| | 18:12 | | | | | | |
| 5 | Flax Oil | — | 33.2 | | | | |
| 21 | Fish Oil | Amine Oxide | 32.8 | 30.6 | 28.7 | 26.9 | 25.4 |
| | 18:12 | | | | | | |
| 22 | Fish Oil | Sulfate | 32.9 | 29.3 | 26.9 | 25.0 | 23.5 |
| | 18:12 | | | | | | |
| 23 | Fish Oil | Sulfate & | 30.7 | 32.1 | 29.8 | 27.9 | 26.3 |
| | 18:12 | Sulfonate | | | | | |
| 24 | Fish Oil | Two Sulfates | 32.5 | 34.4 | 31.4 | 30.0 | 28.9 |
| | 18:12 | | | | | | |
| 25 | Flax Oil | Amine Oxide | 33.2 | 31.3 | 29.4 | 28.1 | 27.1 |
| 26 | Flax Oil | Sulfate | 32.1 | 33.7 | 31.7 | 30.2 | 29.0 |
| 27 | Flax Oil | Sulfate & | 29.5 | 29.8 | 27.3 | 25.6 | 24.3 |
| | | Sulfonate | | | | | |
| 28 | Flax Oil | Two Sulfates | 31.1 | 32.2 | 30.0 | 28.2 | 26.8 |
| 29 | Soybean | Sulfate | — | — | — | — | — |
| | Oil | | | | | | |
| 30 | Soybean | Sulfate | — | — | — | — | — |
| | Oil | | | | | | |

TABLE 7 displays the surface tension and contact angle of samples 4-5, and samples 21-30 after 48 hours. Samples 4 and 5 are noted here to compare the ability of the sample without an MME (samples 4 and 5) as compared to the samples with an MME (samples 21-30). Noted within TABLE 7, samples 29 and 30 had measurable surface tension and contact angles because the VES within the fluid was sufficiently broken after 48 hours and therefore the measurements have improved accuracy.

TABLE 7
48 Hour Surface Tension & Contact Angle Results - Samples 21-30

| | Breaker | | | Contact Angle (48 Hours at | | | |
|---|---|---|---|---|---|---|---|
| | (Oil | Class of MME | Surface | 175° F.) | | | |
| Sample | Phase) | Agent | Tension | 0 minute | 1 minute | 2 minute | 3 minute |
| 4 | Fish Oil | — | 33.2 | 30.9 | 29.1 | 27.2 | 26.1 |
| | 18:12 | | | | | | |
| 5 | Flax Oil | — | 32.4 | 32.3 | 30.0 | 28.6 | 27.4 |
| 21 | Fish Oil | Amine Oxide | 31.9 | 28.4 | 26.7 | 25.0 | 23.4 |
| | 18:12 | | | | | | |
| 22 | Fish Oil | Sulfate | 31.9 | 25.9 | 24.5 | 23.0 | 21.5 |
| | 18:12 | | | | | | |
| 23 | Fish Oil | Sulfate & | 30.5 | 25.8 | 24.2 | 22.3 | 21.1 |
| | 18:12 | Sulfonate | | | | | |
| 24 | Fish Oil | Two Sulfates | 31.7 | 26.1 | 24.0 | 22.2 | 20.4 |
| | 18:12 | | | | | | |
| 25 | Flax Oil | Amine Oxide | 32.8 | 29.0 | 27.0 | 25.4 | 24.1 |
| 26 | Flax Oil | Sulfate | 31.5 | 29.4 | 27.4 | 25.5 | 24.0 |
| 27 | Flax Oil | Sulfate & | 29.8 | 28.2 | 25.8 | 23.8 | 22.0 |
| | | Sulfonate | | | | | |
| 28 | Flax Oil | Two Sulfates | 31.8 | 30.6 | 28.5 | 26.8 | 25.1 |
| 29 | Soybean | Sulfate | 32.0 | 28.0 | 26.2 | 24.5 | 22.7 |
| | Oil | | | | | | |
| 30 | Soybean | Sulfate | 31.8 | 25.0 | 23.5 | 21.9 | 20.4 |
| | Oil | | | | | | |

TABLE 8 displays the surface tension and contact angle of samples 4-5, and samples 21-30 after 96 hours. Samples 4 and 5 are noted here to compare the ability of the sample without an MME (samples 4 and 5) as compared to the samples with an MME (samples 21-30). Noted within TABLE 8, samples 29 and 30 had measurable surface tension and contact angles because the VES within the fluid was sufficiently broken after 96 hours, which is also depicted in the photo of FIG. 4 in the bottom row.

TABLE 8
96 Hour Surface Tension & Contact Angle Results - Sample 21-30

| | Breaker | | | Contact Angle (96 Hours at | | | |
|---|---|---|---|---|---|---|---|
| | (Oil | Class of MME | Surface | 175° F.) | | | |
| Sample | Phase) | Agent | Tension | 0 minute | 1 minute | 2 minute | 3 minute |
| 4 | Fish Oil | — | 31.8 | 25.7 | 24.2 | 22.9 | 21.8 |
| | 18:12 | | | | | | |
| 5 | Flax Oil | — | 31.5 | 26.2 | 24.3 | 23.1 | 22.0 |
| 21 | Fish Oil | Amine Oxide | 31.2 | 24.9 | 23.6 | 21.8 | 20.4 |
| | 18:12 | | | | | | |
| 22 | Fish Oil | Sulfate | 31.1 | 23.3 | 22.0 | 20.9 | 19.5 |
| | 18:12 | | | | | | |
| 23 | Fish Oil | Sulfate & | 30.3 | 21.3 | 19.6 | 18.3 | 17.2 |
| | 18:12 | Sulfonate | | | | | |
| 24 | Fish Oil | Two Sulfates | 31.1 | 23.5 | 21.8 | 20.5 | 19.4 |
| | 18:12 | | | | | | |
| 25 | Flax Oil | Amine Oxide | 32.0 | 23.5 | 21.7 | 20.6 | 19.6 |
| 26 | Flax Oil | Sulfate | 30.8 | 22.6 | 20.7 | 19.5 | 18.6 |
| 27 | Flax Oil | Sulfate & | 29.6 | 20.7 | 18.8 | 17.3 | 16.2 |
| | | Sulfonate | | | | | |
| 28 | Flax Oil | Two Sulfates | 31.6 | 23.9 | 22.0 | 20.3 | 19.2 |
| 29 | Soybean | Sulfate | 30.6 | 23.7 | 22.1 | 20.5 | 19.3 |
| | Oil | | | | | | |
| 30 | Soybean | Sulfate | 30.5 | 22.1 | 20.1 | 18.8 | 17.4 |
| | Oil | | | | | | |

TABLE 9 displays a comparison of the surface tension and contact angle of samples 4-5 and samples 21-30 at 24 hrs, 48 hrs, and 96 hrs. As noted in the table, the surface tension and the contact angle for each sample continued decreasing up to 96 hours. As noted in the 24 hour data, the viscosity was broken within all of the samples at the 24 hours mark at 175° F., except for samples 29 and 30. Samples 29 and 30 had complete viscosity breaking at 48 hours at 175° F. This indicates that constituents within the internal breakers and/or MME agents continued altering the VES broken fluid properties over time, which allows such a fluid to be used initially as a treatment fluid (e.g. viscous fracturing fluid) and a clean-up fluid after the fracturing of the formation has occurred.

TABLE 9
In Situ Microemulsion Curing Time Verses Surface Tension &
Contact Angle Results - Samples 21-30

| | Surface Tension | | | Contact Angle | | |
|---|---|---|---|---|---|---|
| Sample | 24 hrs | 48 hrs | 96 hrs | 24 hrs | 48 hrs | 96 hrs |
| 4 | 34.4 | 33.2 | 31.8 | 27.5 | 26.1 | 21.8 |
| 5 | 33.2 | 32.4 | 31.5 | 29.0 | 27.4 | 22.0 |
| 21 | 32.8 | 31.9 | 31.2 | 25.4 | 23.4 | 20.4 |
| 22 | 32.9 | 31.9 | 31.1 | 23.5 | 21.5 | 19.5 |
| 23 | 30.7 | 30.5 | 30.3 | 26.3 | 21.1 | 17.2 |
| 24 | 32.5 | 31.7 | 31.1 | 28.9 | 20.4 | 19.4 |
| 25 | 33.2 | 32.8 | 32.0 | 27.1 | 24.1 | 19.6 |
| 26 | 32.1 | 31.5 | 30.8 | 29.0 | 24.0 | 18.6 |
| 27 | 30.5 | 29.8 | 29.6 | 24.3 | 22.0 | 16.2 |
| 28 | 32.1 | 31.8 | 31.6 | 26.8 | 25.1 | 19.2 |
| 29 | — | 32.0 | 30.6 | — | 22.7 | 20.6 |
| 30 | — | 31.8 | 30.5 | — | 20.4 | 18.8 |

It will be appreciated that in general the in situ microemulsions herein are oil-in-water microemulsions. Once the reservoir temperature activates the oil-based internal breakers, this will initiate the micelle conversion process, such that at least a portion of the first VES micelles begin to be converted into the second VES micelles. This conversion may take from about 0.5 hr independently to about 48 hours, alternatively from about 1 hrs independently to about 24 hrs. No special mixing equipment or technique is needed to combine the spherical micelles with the oil-based internal hydrocarbon fluid, or the optional component to form the in situ microemulsion.

The invention will be further described with respect to the following Examples, which are not meant to limit the invention, but rather to further illustrate the various embodiments.

### Example 1

Two Berea core samples were cleaned, and the percent return permeabilities were measured using nitrogen gas as the displacement fluid. The cores were initially soaked within 3% bw KCl brine, and permeability to nitrogen gas was performed as the baseline core permeability. One core sample was loaded with VES fluid with fish oil to form a microemulsion, and the other core sample was loaded with VES fluid alone. After 24 hours at 150° F., both core samples were then subjected to flow nitrogen gas for 48 hours to displace the VES fluid from the core sample, and the permeabilities were measured again to compare their base permeabilities. The core sample that was loaded with the microemulsion, i.e. the VES fluid and fish oil noted in FIG. 1 as ‘with microemulsion additive’, had a higher percent return permeability than the core sample that was loaded with VES fluid alone, as noted in FIG. 1 as ‘no microemulsion additive’.

### Example 2

Several types of mineral oils were tested for compatibility in Aromox APA-T (a VES distributed by Akzo Nobel) at 100° F., and the viscosity is shown for each mineral oil in FIG. 2. All of the samples maintained their viscosity, except for the sample having 2 gallons per thousand gallons (gptg) of ESCAID™ 110.

### Example 3

Several types of mineral oils were tested for compatibility in Aromox APA-T (a VES distributed by Akzo Nobel) at 250° F., and the viscosity is shown for each mineral oil in FIG. 3. All of the samples maintained their viscosity, except for the sample having 5.0 gallons per thousand gallons (gptg) of ESCAID™ 110.

### Example 4

FIG. 4 is a photograph illustrating a plurality of VES fracturing fluids (labeled as samples 21-30) being broken and subsequently forming a respective microemulsion. Samples 21-24 include fish oil 18:12; samples 25-28 include flax oil; samples 29-30 include soybean oil. The middle row of samples 21-30 illustrates the composition of the microemulsions within the samples after 24 hours, and the bottom row of samples 21-30 illustrates the composition of the microemulsions within the samples after 96 hours.

As the sample becomes more and more clear over time, this indicates that the polyenoic acid internal breaker continued to auto-oxidize into organic molecules over time. The VES has been completely broken in samples 21-28 after 24 hours, but not completely broken in sample 29-30 as depicted by the somewhat hazy appearance remaining in samples 29-30 as compared to samples 29-30 when initially mixed. However, at 96 hours (the bottom row of the photograph), the VES is completely broken in all of the samples as represented by the clear microemulsions that have formed. FIG. 4, in conjunction with the data from TABLES 6-9, indicates the character and properties of the VES fluid as the VES gelled treatment fluid evolves into its subsequent microemulsion over time; moreover, the in situ microemulsion is not spontaneous after viscosity breaking.

In the foregoing specification, the invention has been described with reference to specific embodiments thereof, and has been described as effective in providing methods and compositions for generating an in situ microemulsion downhole. However, it will be evident that various modifications and changes can be made thereto without departing from the broader spirit or scope of the invention as set forth in the appended claims. Accordingly, the specification is to be regarded in an illustrative rather than a restrictive sense. For example, specific VES compositions, surfactants, co-surfactants, types of micelles, oil-based internal breakers, and other internal breakers, additional components, and clean-up agents falling within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, the method may consist of or consist essentially of generating an in situ microemulsion downhole by breaking the viscosity of a VES gelled aqueous fluid with a first oil-based internal breaker where an in situ microemulsion forms in situ downhole with at least a portion of spherical micelles from the broken gelled aqueous fluid for increasing the rate of flowback of an internally broken VES treatment fluid, increasing the volume of treatment fluid recovered, increasing the relative permeability of a hydrocarbon stream, e.g. oil, gas, and the like; decreasing water saturation of a hydrocarbon stream, reducing capillary pressure and water-block in the reservoir, enhancing the solubilization and dispersion of viscoelastic surfactant molecules, enhancing the solubilization and dispersion of internal breakers and/or internal breaker by-products when breaking a VES gel, reducing the interfacial tension at the fluid-rock interface, reducing the contact angle at the rock-fluid interface, reducing the water/oil interfacial tension, keeping the reservoir surfaces water-wet, and combinations thereof. The composition may consist of or consist essentially of an in situ microemulsion generated downhole, wherein the in situ microemulsion may include at least a portion of spherical micelles from a broken gelled aqueous fluid and a first oil-based internal breaker; a hydrocarbon fluid different from the first oil-based internal breaker may combine with at least a portion of the spherical micelles and an additional component, such as but not limited to a second oil-based internal breaker, a clean-up agent, an emulsifying agent, and combinations thereof to form the in situ microemulsion downhole.

The words “comprising” and “comprises” as used throughout the claims, are to be interpreted to mean “including but not limited to” and “includes but not limited to”, respectively.

What is claimed is:

1. A method for generating an in situ microemulsion downhole, wherein the method comprises:
breaking the viscosity of a VES gelled aqueous fluid with a first oil-based internal breaker, wherein the broken gelled aqueous fluid comprises spherical micelles; and
forming in situ an in situ microemulsion downhole comprising at least a portion of the spherical micelles, the first oil-based internal breaker, and an additional component selected from the group consisting of a second oil-based internal breaker, a clean-up agent, an emulsifying agent, and combinations thereof; and
wherein the in situ microemulsion performs a function selected from the group consisting of increasing the rate of flowback of an internally broken VES treatment fluid; increasing the volume of treatment fluid recovered; increasing the relative permeability of a hydrocarbon stream; decreasing water saturation of a hydrocarbon stream; reducing capillary pressure and water-block in the reservoir; enhancing the solubilization and dispersion of viscoelastic surfactant molecules; enhancing the solubilization and dispersion of internal breakers, internal breaker by-products, and mixtures thereof when breaking a VES gel; reducing the interfacial tension at the fluid-rock interface; reducing the contact angle at the fluid-rock interface; reducing the roll-off angle adhesion property at the fluid-rock interface; reducing the aqueous treatment fluid/formation oil interfacial tension; keeping the reservoir surfaces water-wet; and combinations thereof.

2. The method of claim 1, wherein the first oil-based internal breaker is selected from the group consisting of mineral oil, natural oil, and combinations thereof.

3. The method of claim 2, wherein the mineral oil has a viscosity ranging from about 0.5 cps to about 120 cps.

4. The method of claim 1, wherein the in situ microemulsion further breaks the viscosity of the VES gelled aqueous fluid.

5. The method of claim 1, wherein the clean-up agent is selected from the group consisting of a polymeric surfactant, surfactant, polyol, solvent, and combinations thereof.

6. The method of claim 1, wherein the emulsifying agent is selected from the group consisting of a surfactant, a polymer, an oil, and combinations thereof.

7. The method of claim 1, wherein the VES is selected from the group consisting of an amine oxide, a betaine, a quaternary amine, a sarcosinate, and combinations thereof.

8. The method of claim 1, wherein the in situ microemulsion further comprises a hydrocarbon fluid different from the first oil-based internal breaker.

9. A method for generating an in situ microemulsion downhole, wherein the method comprises:
breaking the viscosity of a viscoelastic surfactant (VES) gelled aqueous fluid with a first oil-based internal breaker, wherein the VES gelled aqueous fluid comprises a plurality of first VES micelles;
converting at least a portion of the first VES micelles into second VES micelles;
forming in situ an in situ microemulsion downhole comprising at least a portion of the second VES micelles; and
wherein the in situ microemulsion performs a function selected from the group consisting of increasing the rate of flowback of an internally broken VES treatment fluid; increasing the volume of treatment fluid recovered, increasing the relative permeability of a hydrocarbon stream; decreasing water saturation of a hydrocarbon stream; reducing capillary pressure and water-block in the reservoir; enhancing the solubilization and dispersion of viscoelastic surfactant molecules; enhancing the solubilization and dispersion of internal breakers, internal breaker by-products, and mixtures thereof when breaking a VES gel; reducing the interfacial tension at the fluid-rock interface; reducing the contact angle at the fluid-rock interface; reducing the roll-off angle adhesion property at the fluid-rock interface; reducing the aqueous treatment fluid/reservoir oil interfacial tension; keeping the reservoir surfaces water-wet; and combinations thereof.

10. The method of claim 9, wherein the VES gelled aqueous fluid further comprises an additional component selected from the group consisting of a second oil-based internal breaker, a clean-up agent, an emulsifying agent, and combinations thereof with the first oil-based internal breaker.

11. The method of claim 10, wherein the second oil-based internal breaker is different from the first oil-based internal breaker, and wherein the second oil-based internal breaker is selected from the group consisting of mineral oil, natural oil, and combinations thereof.

12. The method of claim 9, wherein the second VES micelles differ in shape from the first VES micelles.

13. The method of claim 9, wherein the first VES micelles comprise viscous elongated micelles, and wherein the second VES micelles comprise spherical micelles.

14. An in situ microemulsion generated downhole, wherein the in situ microemulsion comprises:
at least a portion of spherical micelles from a broken viscoelastic surfactant (VES) gelled aqueous fluid; and
a hydrocarbon fluid, wherein the hydrocarbon fluid combines with at least a portion of the spherical micelles and an additional component to form the in situ microemulsion, and wherein the additional component is selected from the group consisting of a second oil-based internal breaker, a clean-up agent, an emulsifying agent, and combinations thereof.

15. The in situ microemulsion of claim 14, wherein the broken VES gelled aqueous fluid comprises a first oil-based internal breaker selected from the group consisting of mineral oil, natural oil, and combinations thereof.

16. The in situ microemulsion of claim 15, wherein the in situ microemulsion further comprises a second oil-based internal breaker different from the first oil-based internal breaker, and wherein the second oil-based internal breaker is selected from the group consisting of mineral oil, natural oil, and combinations thereof.

17. The in situ microemulsion of claim 15, wherein the mineral oil has a viscosity ranging from about 0.5 cps to about 120 cps.

18. The in situ microemulsion of claim 14, wherein the clean-up agent is selected from the group consisting of a polymeric surfactant, surfactant, polyol, solvent, and combinations thereof.

19. The method of claim 14, wherein the emulsifying agent is selected from the group consisting of a surfactant, a polymer, an oil, and combinations thereof.

20. An in situ microemulsion generated downhole, wherein the in situ microemulsion comprises:
at least a portion of second VES micelles and a first oil-based internal breaker, wherein the second VES micelles were converted from a plurality of first VES micelles once a VES gelled aqueous fluid was broken; and
a hydrocarbon fluid different from the first oil-based breaker, wherein the hydrocarbon fluid combines with at least a portion of the second VES micelles to form the in situ microemulsion downhole.
